(19) United States
(12) Patent Application Publication
(10) Pub. No.: US 2019/0030790 A1
(43) Pub. Date: Jan. 31, 2019

(54) METHOD FOR PRODUCING THREE-DIMENSIONAL SHAPED ARTICLE, AND FILAMENT FOR PRODUCING THREE-DIMENSIONAL SHAPED ARTICLE

(71) Applicant: MASANORI FUJITA, TOKYO (JP)

(72) Inventor: MASANORI FUJITA, TOKYO (JP)

(21) Appl. No.: 16/072,320

(22) PCT Filed: Oct. 5, 2016
(86) PCT No.: PCT/JP2016/079605

§ 371 Date: Jul. 24, 2018

(30) Foreign Application Priority Data
Jan. 26, 2016 (JP) 2016-012209

(51) Int. Cl. B29C 64/118; B33Y 70/00

(52) U.S. Cl. CPC B29C 64/118; B29K 2023/12; B33Y 70/00

(57) ABSTRACT

Provided are: a filament for use in production of a three-dimensionally shaped product, the filament using a generally-used thermoplastic resin; and a method for producing the three-dimensionally shaped product, by use of the filament. The method for producing the three-dimensionally shaped product, through a hot-melting and layering process, comprises: a melting step for melting glass wool-filled thermoplastic resins filled with glass wool; and a layering step for layering the glass wool-filled thermoplastic resins having been melted.

### BACKGROUND OF THE INVENTION

### 1.Field of the Invention

The present invention relates to a method for producing a three-dimensional shaped article, and a filament for producing a three-dimensional shaped article.

### 2.Description of the Related Art

A 3D printer is a device that uses 3DCAD and 3DCG data as a design drawing to layer a cross-sectional shape of the drawing and produce a three-dimensional shaped article. Various schemes for 3D printers are known. Typical schemes include: fused deposition modeling (FDM) in which a thermoplastic resin (filament) is melted by heat and gradually layered; optical shaping schemes in which melted resin in a liquid state is irradiated with UV rays or the like and gradually cured and molded; powder sintering-layering-shaping schemes in which an adhesive is blown onto a powder resin; and inkjet schemes.

Among the above-noted schemes, a FDM 3D printer is capable of producing a three-dimensional shaped article by

(1) first, extruding a filament formed from a thermoplastic resin using a pulley in a shaping head, and

(2) subsequently, performing layering such that the extruded thermoplastic resin is pressed against a shaping table while the filament is melted by an electric heater (see Patent Document 1).

A filament used in a FDM 3D printer is known to have a problem in that contraction-induced warping occurs when a shaped article is produced depending on the type of thermoplastic resin (see Patent Document 2). For this reason, the invention described in Patent Document 2 provides a material for a fused deposition model three-dimensional shaped article obtained by blending 10 to 900 parts by weight of a styrene resin (B1) having a weight-average molecular weight of 50,000 to 400,000 and in which a monomer mixture containing 20 mass % or more of an aromatic vinyl monomer (b1) and 15 mass % or more of a vinyl cyanide monomer (b2) are polymerized, and/or 5 to 400 parts by weight of at least one type of thermoplastic resin (B2) selected from the group consisting of a polyester, a thermoplastic elastomer, and a graft copolymer and having a glass transition temperature of 20° C. or less, and/or 5 to 30 parts by weight of an ester plasticizer, with respect to 100 parts by weight of a polylactic acid resin (A) having a weight-average molecular weight of 50,000 to 400,000, whereby the occurrence of warping of a fabricated shaped article is inhibited.

[Patent Document 1] WO 2008/112061

[Patent Document 2] Japanese Patent No. 5751388

### SUMMARY OF THE INVENTION

In recent years, the cost of FDM 3D printers has decreased, and introduction to schools, general households, and the like has expanded. In order to have 3D printers to be more greatly used in schools, general households, and the like, the dissemination of filaments for producing a three-dimensional shaped article is an important factor. However, the material (filament) for producing three-dimensional shaped article described in Patent Document 2 is a resin developed especially for FDM three-dimensional shaping, and is not a general-purpose thermoplastic resin. For this reason, there is a need to develop a filament capable of producing a high-precision three-dimensional shaped article in which a general-purpose thermoplastic resin readily obtainable worldwide is the basic material and in which warping or the like does not occur even when used as a filament for producing a FDM three-dimensional shaped article.

The present disclosure was devised to solve the above-described problems, and after thoroughgoing research, it was newly found that

(1) when a filament obtained by adding glass wool (short glass fiber) to a thermoplastic resin is used, the percentage of contraction of the thermoplastic resin when the thermoplastic resin is melted and cooled is reduced, thereby making it possible to inhibit the occurrence of warping and carry out high-precision laminate molding, and

(2) as a result, a general-purpose thermoplastic resin can be used as the material of the filament for producing a three-dimensional shaped article by a FDM 3D printer.

In other words, an object of the present disclosure relates to a filament for producing a three-dimensional shaped article using a general-purpose thermoplastic resin, and to a method for producing a three-dimensional shaped article using the filament.

The present invention described below relates to a method for producing a three-dimensional shaped article and to a filament for producing a three-dimensional shaped article.

(1) A method for producing a three-dimensional shaped article by fused deposition modeling, the method comprising:

a melting step for melting a glass-wool-containing thermoplastic resin containing glass wool; and

a layering step for layering the melted glass-wool-containing thermoplastic resin.

(2) The method for producing a three-dimensional shaped article of (1) above, wherein the amount of glass wool contained in the glass-wool-containing thermoplastic resin is 5 to 40 wt %.

(3) The method for producing a three-dimensional shaped article of (2) above, wherein the amount of glass wool contained in the glass-wool-containing thermoplastic resin is 15 to 25 wt %.

(4) The method for producing a three-dimensional shaped article of any of (1) to (3) above, wherein the thermoplastic resin is polypropylene or polyacetal.

(5) A filament for producing a three-dimensional shaped article by fused deposition modeling, wherein

the filament is a glass-wool-containing thermoplastic resin containing glass wool.

(6) The filament for producing a three-dimensional shaped article of (5) above, wherein the amount of glass wool contained in the glass-wool-containing thermoplastic resin is 5 to 40 wt %.

(7) The filament for producing a three-dimensional shaped article of (6) above, wherein the amount of glass wool contained in the glass-wool-containing thermoplastic resin is 15 to 25 wt %.

(8) The filament for producing a three-dimensional shaped article of any of (5) to (7) above, wherein the thermoplastic resin is polypropylene or polyacetal.

(9) The filament for producing a three-dimensional shaped article of any of (5) to (8) above, wherein the filament has a diameter of 1.75 mm to 2.85 mm and a length of at least 50 cm or more.

### EFFECTS OF THE INVENTION

The percentage of contraction can be reduced by using a glass-wool-containing thermoplastic resin that includes glass wool in a thermoplastic resin when a FDM three-dimensional shaped article is to be produced. As a result, it is possible to obtain a three-dimensional shaped article produced with inhibited warping and high dimensional precision. Therefore, a general-purpose thermoplastic resin having a high percentage of heat contraction, which could not conventionally be used to produce a three-dimensional shaped article by FDM, can be used as a material for producing a three-dimensional shaped article by FDM.

### BRIEF DESCRIPTION OF THE DRAWINGS

FIG. 1 shows photographs in lieu of drawings, FIG. 1(A) being a photograph of glass wool, and FIG. 1(B) being a photograph of glass fiber;

FIG. 2 shows a photograph in lieu of a drawing, and a photograph of the filament fabricated in example 2;

FIG. 3 shows photographs in lieu of drawings in relation to comparative example 2, FIG. 3(A) being a photograph of a shaping table prior to the start of layering, FIG. 3(B) being a photograph in which a thermoplastic resin is made to anchor to the holes of the shaping table and layering is carried out so that the layered thermoplastic resin does not peel away from the shaping table, FIG. 3(C) being a photograph of ongoing fabrication of a raft for placement of a three-dimensional shaped article with thermoplastic resin being further layered on the thermoplastic resin which was made to anchor to the holes of the shaping table, FIG. 3(D) being a photograph of a 3D printer nozzle being fabricated on the raft, and FIG. 3(E) being a photograph taken immediately after the thermoplastic resin anchored to the holes of the shaping table had peeled away due to contraction on the shaping table, and shrinkage cavities and warping intrinsic to polypropylene have occurred;

FIG. 4 shows photographs in lieu of drawings, FIG. 4(A) being a photograph of the three-dimensional shaped article fabricated in example 5, and FIG. 4(B) being a photograph of the three-dimensional shaped article fabricated in example 6;

FIGS. 5(A) and 5(B) show photographs in lieu of drawings, and are photographs of the three-dimensional shaped article fabricated in example 6;

FIG. 6 shows photographs in lieu of drawings, FIG. 6(A) being a photograph of the three-dimensional shaped article fabricated in example 8, FIG. 6(B) being a photograph of the three-dimensional shaped article fabricated in example 9, FIG. 6(C) being a photograph of the three-dimensional shaped article fabricated in example 10, and FIG. 6(D) being an enlarged photograph of the FIG. 6(C);

FIG. 7 shows photographs in lieu of drawings, FIG. 7(A) being a photograph of ongoing fabrication of a raft for placement of a three-dimensional shaped article with thermoplastic resin being further layered on the thermoplastic resin which was made to anchor to the holes of the shaping table, FIG. 7(B) being a photograph in which the thermoplastic resin has been layered on the raft, and FIG. 7(C) being a photograph of the three-dimensional shaped article fabricated in example 11; and

FIG. 8 shows photographs in lieu of drawings, FIG. 8(A) being a photograph of ongoing fabrication of a raft for placement of a three-dimensional shaped article with thermoplastic resin being further layered on the thermoplastic resin which was made to anchor to the holes of the shaping table, FIG. 8(B) being a photograph in which the thermoplastic resin has been layered on the raft, and FIG. 8(C) being a photograph of the three-dimensional shaped article fabricated in comparative example 3.

### DETAILED DESCRIPTION OF THE PREFERRED EMBODIMENTS

The following is a detailed description of the method for producing a three-dimensional shaped article of the present invention (hereinbelow, may merely be referred to as “production method”), and a filament for producing a three-dimensional shaped article (hereinbelow, may merely be referred to as “filament”).

The production method of the present disclosure produces a three-dimensional shaped article by FDM. The device used in the production method of the present disclosure is not particularly limited as long as an FDM-scheme 3D printer is used. The production method of the present disclosure includes “a melting step for melting a glass-wool-containing thermoplastic resin containing glass wool” and “a layering step for layering the melted glass-wool-containing thermoplastic resin.”

First, in the melting step, a filament is extruded by a pulley or other delivery means inside the shaping head of the 3D printer, and the filament is heated and melted by an electric heater or other heating section positioned at the tip of extrusion. Next, in the layering step, layering is carried out so as to press the melted filament against a shaping table and thereby form a first resin layer. The shaping table is lowered an equivalent of one layer and the melting step and layering step are repeated to thereby form a second layer. Lowering the shaping table an equivalent of one layer and repeating the melting step and layering step for a plurality of cycles allows a three-dimensional shaped article to be produced.

The thermoplastic resin constituting the filament of the present disclosure is not particularly limited as long as the resin can contain glass wool, and examples include general-purpose plastics, engineering plastics, super engineering plastics, and other conventional thermoplastic resins. Specific examples of general-purpose plastics include polyethylene (PE), polypropylene (PP), polyvinyl chloride (PVC), polyvinylidene chloride, polystyrene (PS), polyvinyl acetate (PVAc), polytetrafluoroethylene (PTFE), acrylonitrile butadiene styrene resin (ABS resin), styrene-acrylonitrile copolymer (AS resin), and acrylic resin (PMMA). Examples of engineering plastics include nylons typified by polyamide (PA), polyacetal (POM), polycarbonate (PC), modified polyphenylene ether (m-PPE, modified PPE, PPO), polybutylene terephthalate (PBT), polyethylene terephthalate (PET), syndiotactic polystyrene (SPS), and cyclic polyolefins (COP). Examples of super engineering plastics include polyphenylene sulfide (PPS), polytetrafluoroethylene (PTFE), polysulfone (PSF), polyethersulphone (PES), amorphous polyarylate (PAR), polyether ether ketone (PEEK), and thermoplastic polyimide (PI), polyamide-imide (PAI). These resins may be used in combination with one or more types.

Currently, ABS resin and PLA resin (polylactic acid) are often used in FDM. This is because ABS resin is an amorphous resin and therefore has a relatively low percentage of heat contraction of about 4/1000 to 9/1000. PLA resin (polylactic acid) is a plant-derived resin and melts at a low temperature, and therefore has a low percentage of heat contraction when melted and cooled. In the above-described production steps, when the shaping table is lower an equivalent of one layer, the thermoplastic resin of the lowered layer proceeds to solidify due to cooling, and it is at this point that warping occurs when the percentage of heat contraction is high. Consequently, a gap is generated in the boundary between the lowered layer even when the melted thermoplastic resin is pressed onto the lowered layer. Therefore, ABS resin, PLA resin, and other resins having a low percentage of heat contraction have conventionally been used in FDM.

The filament of the present disclosure is obtained by adding glass wool to the thermoplastic resin, thereby making it possible inhibit warping that occurs when the thermoplastic resin melts and the thermoplastic resin subsequently contracts when cooled. Therefore, in addition to AB resin and PLA resin which have been used conventionally, crystalline resins having a relatively high percentage of heat contraction can also be used as the thermoplastic resin of the filament of the present disclosure. Examples of crystalline resins include polypropylene (PP, percentage of heat contraction: about 10/1000 to 25/1000), high-density polyethylene (HDPE, percentage of heat contraction: about 20/1000 to 60/1000), polybutylene terephthalate (PBT, percentage of heat contraction: about 15/1000 to 20/1000), and polyacetyl (POM, percentage of heat contraction: about 20/1000 to 25/1000).

Among crystalline resins, polypropylene has low specific gravity and yet has high strength, has no hygroscopic properties, and has excellent chemical resistance. Furthermore, polypropylene has a wide usage range as a general-purpose thermoplastic resin in light of its maximum heat resistance and other characteristics, and is indispensable in industrial products in being a material used in automobiles, home appliances, OA machines, construction materials, housing materials, household products, and the like. The percentage of heat contraction of polypropylene is relatively high at about 10/1000 to 25/1000, but adding glass wool makes it possible to produce a three-dimensional shaped article with reduced warping, as shown in the later-described examples and comparative examples.

Together with polyamide, polycarbonate, modified polyphenylene ether, and polybutylene terephthalate, polyacetal (POM) is counted among of the five major general-purpose engineering plastics. Polyacetal has excellent abrasion resistance, a self-lubricating property, excellent mechanical characteristics such as rigidity and toughness, and has high temperature stability. Accordingly, polyacetal is often used as a substitute for metal, examples of which include gears (cogwheels), bearings, grips, hooks, covers, and other parts that require durability. Polyacetal is often recently used in recorders, woodwind instruments, brass-wind instruments, and other parts that require functionality. Polyacetal has the highest percentage of heat contraction among the engineering plastics at about 20/1000 to 25/1000. However, adding glass wool makes it possible to produce a three-dimensional shaped article with reduced warping, as shown in the later-described examples and comparative examples.

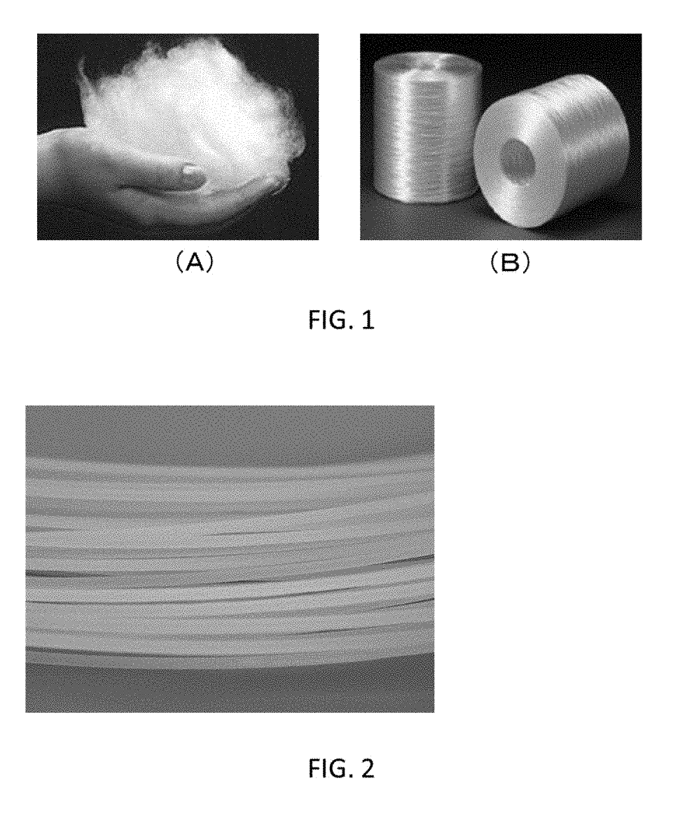

As used in the present disclosure, glass wool refers to flocculent glass fiber having a fiber diameter of about 1 to 7μm and a fiber length of about 300 to 1000 μm. FIG. 1(A) is a photograph of glass wool. Glass fiber (long glass fiber) having a fiber diameter of 10 to 18 μm is also known as a reinforcement material added to thermoplastic resin or the like (see FIG. 1(B)). Glass fiber is commonly known as a chopped strand in which 50 to 200 fibers have been brought together and cut to a predetermined length. As shown in FIGS. 1(A) and 1(B), glass wool and glass fiber are completely different in terms of production method and use.

Glass wool is produced by causing a spinner provided with numerous small holes of about 1 mm at the periphery to rotate at high speed to jet melted glass. The production process is commonly referred to as centrifuging, and adjusting the viscosity of the melted glass and the rotational speed makes it possible to economically produce fine glass wool of about 1 to 7 μm. Glass wool can be produced using the above-described method or a commercially available product may be used.

Glass wool is an inorganic material, but a thermoplastic resin is an organic material. Therefore, when glass wool is merely added to a thermoplastic resin, the adhesiveness between the glass wool and the thermoplastic resin is reduced. For this reason, the glass wool may be surface-treated with a silane coupling agent and thereafter added to the thermoplastic resin.

The silane coupling agent is not particularly limited as long as the agent is conventionally used, and can be determined with consideration given to reactivity with the thermoplastic resin constituting the filament, heat stability, and other factors. Examples of the silane coupling agent include aminosilanes, epoxysilanes, allylsilanes, and vinylsilanes. These silane coupling agents may be the Z series manufactured by Dow Corning Toray, the KBM series and KBE series manufactured by Shin-Etsu Chemical Co., products manufactured by JNC Corp., and other commercially available products.

The glass wool can be surface treated by dissolving the silane coupling agent in a solvent, and then spraying and drying the solution on the glass wool. The weight percentage of the silane coupling agent with respect to the glass wool is 0.1 to 2.0 wt %, preferably 0.15 to 0.4 wt %, and more preferably 0.24 wt %.

In the present disclosure, the glass wool may be surface treated using a lubricant. The lubricant is not particularly limited as long as the slippage of the glass wool is improved and addition to the thermoplastic resin is facilitated when the glass wool is kneaded into the thermoplastic resin. Examples that may be used include silicone oil and other conventionally used lubricants, but a calixarene is particularly preferred. Silicone is an oil and therefore has poor compatibility with the thermoplastic resin, but calixarene is a phenolic resin that improves glass wool slippage, has excellent compatibility with the thermoplastic resin, and can therefore be added to the thermoplastic resin while the fiber length of the glass wool is maintained.

The surface of the glass wool is treated by spraying and drying the solution, in which the calixarene has been dissolved, on the glass wool. The solution in which the calixarene has been dissolved can be manufactured using a known manufacturing method. For example, a plastic modifier nanodaX (registered trademark) manufactured by NANODAX CO., Ltd. may be used. The weight percentage of the plastic modifier nanodaX (registered trademark) with respect to the glass wool is preferably 0.001 to 0.5 wt %, and more preferably 0.01 to 0.3 wt %.

The glass wool may be treated using the above-described silane coupling agent or lubricant, or may be treated using the silane coupling agent and lubricant.

In addition to surface treatment by the silane coupling agent and/or lubricant, the glass wool of the present disclosure may also be surface treated using an epoxy resin, vinyl acetate resin, vinyl acetate copolymer resin, urethane resin, acrylic resin, or other known film-forming agent. These film-forming agents may be used alone or in a mixture of two or more agents, and the weight percentage of the film-forming agent is preferably 5 to 15 times more than the silane coupling agent.

The filament of the present disclosure may be manufactured by melting and kneading the various additives to be added as required, and the thermoplastic resin and the surface-treated glass wool using a single-screw or multiple-screw extruder, a kneader, mixing roller, Banbury mixer, or other known melt-kneader, at a temperature of 200 to 400° C., and extruding the mixture in a linear form. The manufacturing device is not particularly limited, but melting and kneading is carried out in a simple manner using a twin-screw extruder and is preferred. Alternatively, it is also possible to mix and melt master pellets that have high glass wool content with thermoplastic resin pellets that do not contain glass wool, and extrude the mixture in a linear form.

The thickness of the filament is not particularly limited as long as the size allows the filament to be used in a known FDM 3D printer. For example, the thickness may be about 1.75 mm to 2.85 mm when the filament is to be used in a currently marketed FDM 3D printer. Naturally, when the model of the FDM 3D printer is changed, the thickness of the filament can be adjusted so as to permit accommodation in the model. The thickness of the filament refers to the diameter obtained when a circular cross section has been cut perpendicular to the lengthwise direction of the filament, and refers to the length of the longest line connecting any two points of the cross section when the cross section is not circular. The length of the filament is not particularly limited as long as the filament can be continuously fed out by feeding means of the 3D printer. A greater length is preferred in that time and effect to reset the filament can be reduced, at least 50 cm or more being preferred, and 100 cm or more being even more preferred. On the other hand, the upper limit of the filament length is not particularly limited as long as the length can be taken up by a reel or the like. In the case of a commercially available product, a prescribed length may be selected. For example, when continuous use is high, the length can be 500 m or less, 400 m or less, 300 m or less, or the like. In the case of colored special use, the length may be, e.g., 10 m or less, 5 m or less, or the like. The thickness of the filament can be adjusted by extruding molten thermoplastic resin containing glass wool from a nozzle in which a hole of an expected size has been formed. The extruded glass-wool-containing thermoplastic resin can be taken up in the form of a coil onto a reel (bobbin) in order to obtain a long filament. As used in the present disclosure, the term “filament” refers to a linear glass-wool-containing thermoplastic resin having a sufficient length with respect to the thickness as described above, and is different from a granular pellet.

In the filament of the present disclosure, the amount of glass wool contained in the glass-wool-containing thermoplastic resin is not particularly limited as long as the amount inhibits heat contraction of the thermoplastic resin to within an expected range. For example, in the case of polypropylene, which has a relatively high percentage of heat contraction, the amount of glass wool to be added is preferably about 5 wt % or more, more preferably 10 wt % or more, and particularly preferred is 15 wt % or more. When the amount of glass wool to be added is 5 wt % or less, the percentage of heat contraction is high when the filament is layered and cooled, the surface of the three-dimensional shaped article becomes rough, and layering becomes difficult.

On the other hand, the upper limit of the glass wool content is not particularly limited from the viewpoint of percentage of heat contraction. However, when the glass wool content exceeds 40 wt %, abrasion of the nozzle is increased, the nozzle being a critical part of a FDM 3D printer. Also, the thermoplastic resin melts and fluidity is increased, but the glass wool is flocculent. Accordingly, when the filament is heated and thermoplastic resin melts, the thermoplastic resin and the glass wool are less likely to move in integral fashion. As a result, the thermoplastic resin and the glass wool separate and become difficult to press in integral fashion in the layering step, and undesirable dripping occurs during layering. Therefore, the glass wool content is preferably 40 wt % or less, more preferably 35 wt % or less, even more preferably 30 wt % or less, and particularly preferred is 25 wt % or less. The range of the glass wool content is preferably about 5 to 40 wt %, and more preferably 15 to 25 wt %

As long as the thermoplastic resin is ABS or another resin having a low percentage of heat contraction, the glass wool content may be less than 5 wt % from the viewpoint of reducing the percentage of heat contraction of the thermoplastic resin after the layering step. On the other hand, when the glass wool content is high, the strength of the three-dimensional shaped article is enhanced. Therefore, the glass wool content in the glass-wool-containing thermoplastic resin can be set to about 5 to 40 wt % without regard to the type of thermoplastic resin. Setting the glass wool content to the above-stated range makes it possible to demonstrate two different effects, namely, inhibiting heat contraction of the thermoplastic resin and producing a three-dimensional shaped article with enhanced strength.

Known UV absorbers, stabilizers, antioxidants, plasticizers, coloring agents, orthochromatic agents, flame retardants, antistatic agents, fluorescent whitening agents, delustering agents, impact strength improvers, and other additives can be added to the filament of the present disclosure in a range that does not depart from the purpose of the present disclosure.

The present inventor made a patent application for a composite-forming material containing glass wool in a thermoplastic resin (see Japanese Patent No. 5220934). However, the composite-forming material described in Japanese Patent No. 5220934 is an invention for increasing the length of glass wool fibers and the glass wool content in the thermoplastic resin, and the mode as a product is only a description of pellets for injection molding and an injection-molded article. On the other hand, the filament of the present disclosure has a long, thin, linear shape so that it can be used for producing a three-dimensional shaped article by FDM. Therefore, the filament of the present disclosure is novel in being different in shape as a product and different in application from the composite-forming material described in Japanese Patent No. 5220934.

The present disclosure is described in detail below using examples, and the examples are merely provided for reference as specific modes in order to describe the present disclosure. The exemplifications are for describing particular specific modes of the present disclosure, and do not represent a limitation or restriction of the scope of the disclosure disclosed in the present application.

### EXAMPLES

### Example 1

[Fabrication of Master Batch Pellets]

Polypropylene (PP, AZ564 manufactured by Sumitomo Chemical Co., Ltd.) was used as the thermoplastic resin. The glass wool was manufactured by the centrifuge method, and the average fiber diameter was about 3.6 μm.

The glass wool surface treatment was carried out by spraying a solution containing a silane coupling agent from a binder nozzle onto glass wool fiberized from a spinner. Aminosilane coupling agent 5330 (manufactured by JNC Corp.) was used as the silane coupling agent. The weight percentage of the silane coupling agent with respect to the glass wool was 0.24 wt %.

The glass wool was thereafter dried for one hour at 150° C. and then cracked into fibers having an average length of 850 μm using a cutter mill. Using a unidirectional twin-screw kneading extruder ZE40A ((ϕ43 L/D =40) manufactured by KraussMaffei Berstorff) as the extrusion molding machine, and a weight-based screw feeder S210 (manufactured by K-Tron Technologies) as the weighing device, glass wool was added to and kneaded with melted polypropylene so that the ratio of glass wool in the glass-wool-containing polypropylene reached 40 wt %. Kneading was carried out under the conditions of a screw speed of 150 rpm, a resin pressure of 0.6 Mpa, an electric current of 26 to 27A, and a feed rate of 12 Kg/hr. The resin temperature of the polypropylene during kneading was 190 to 280° C., and the glass wool was heated to and added at 100° C. After kneading, master batch pellets were fabricated.

[Filament Fabrication]

The fabricated master batch pellets were melted using PP manufactured by Sumitomo Chemical Co., Ltd., and a filament was fabricated by extrusion from a filament molding die of an extrusion molding machine. The thickness of the fabricated filament was 1.75 mm (±0.05 mm), and the filament was taken up by a reel (bobbin) to complete fabrication.

### Examples 2 to 4

During the [Filament fabrication] of example 1, polypropylene that did not contain glass wool was added to the master batch pellets, which were then mixed and melted to thereby fabricate filaments having an in-filament glass wool content of 20 wt %, 10 wt %, and 5 wt %.

### Comparative Example 1

A filament fabricated using only polypropylene without an addition of glass wool was used as comparative example 1.

Table 1 shows the glass wool content in the filaments fabricated in examples 1 to 4 and working example 1.

TABLE 1

| | Example | Example | Example | Example | Working |
|---|---|---|---|---|---|
| | 1 | 2 | 3 | 4 | example 1 |
| Content of | 40 wt % | 20 wt % | 10 wt % | 5 wt % | 0 |
| short glass | | | | | |
| wool | | | | | |

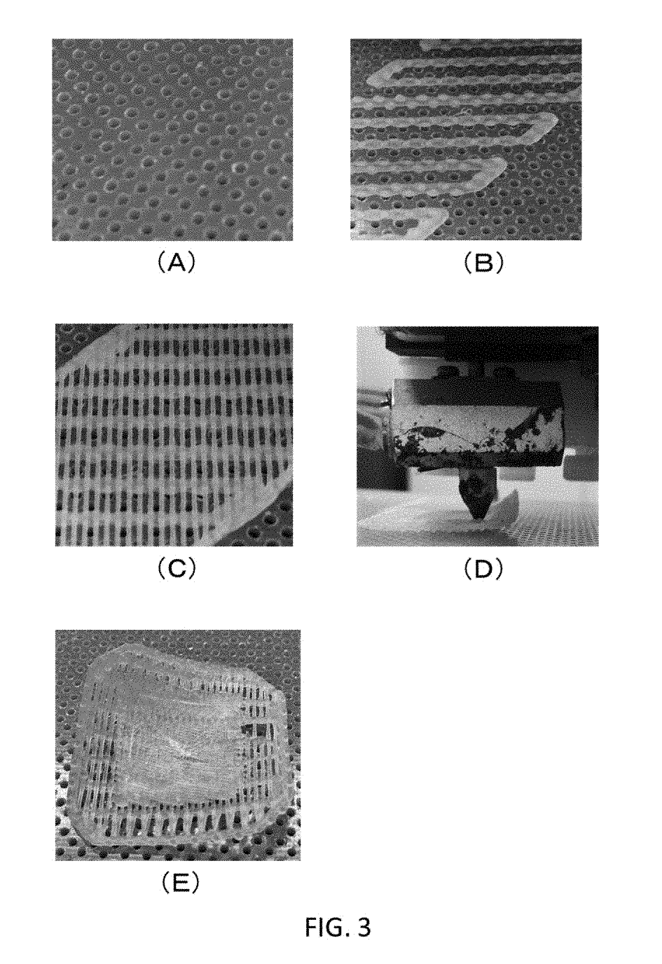

FIG. 2 is a photograph of the filament fabricated in example 2.

[Fabrication of a Three-Dimensional Shaped Article]

### Comparative Example 2

The filament fabricated in comparative example 1 was set in the nozzle portion of a FDM 3D printer (MUTOH Value 3D MagiX MF-500). Next, the nozzle temperature was set to 250 to 270° C. and the shaping speed was set to 25 mm/s, and the thermoplastic resin was layered by pressing the filament onto the shaping table while the filament was melted.

FIG. 3(A) is a photograph of a shaping table prior to the start of layering;

FIG. 3(B) is a photograph in which a thermoplastic resin is made to anchor to the perforated plate of the shaping table, and layering is carried out so that the layered thermoplastic resin does not peel away from the shaping table;

FIG. 3(C) is a photograph of ongoing fabrication of a raft for placement of a three-dimensional shaped article with thermoplastic resin being further layered on the thermoplastic resin which was made to anchor to the holes of the shaping table;

FIG. 3(D) is a photograph of a 3D printer nozzle being fabricated on the raft; and

FIG. 3(E) is a photograph taken immediately after the thermoplastic resin anchored to the holes of the shaping table had peeled away due to contraction on the shaping table, and shrinkage cavities and warping intrinsic to polypropylene have occurred.

As shown in FIG. 3(E), thermoplastic resin could no longer be layered at the point when the thermoplastic resin displaced from the shaping table. As described above, the three-dimensional shaped article could no longer be fabricated using the filament of comparative example 1, which was fabricated using only polypropylene that does not contain glass wool.

### Example 5

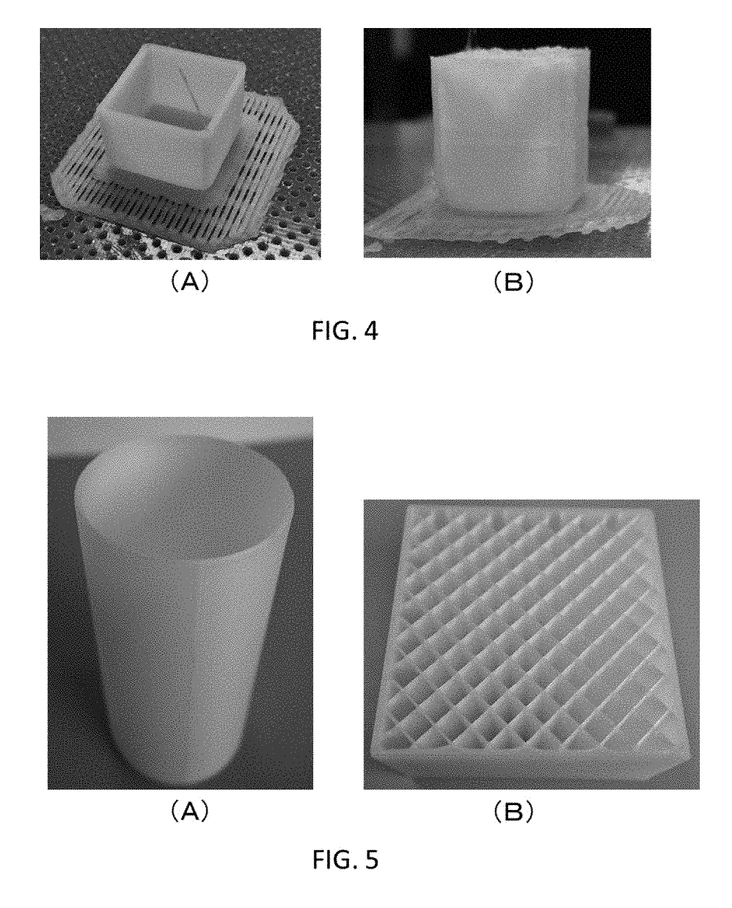

Other than using the filament fabricated in example 2, the filament was set in the 3D printer using the same procedure as comparative example 2, and a three-dimensional shaped article was fabricated by repeated layering. FIG. 4(A) is a photograph of the three-dimensional shaped article fabricated in example 5.

### Example 6

Other than using the filament fabricated in example 3, the filament was set in the 3D printer using the same procedure as example 5, and a three-dimensional shaped article was fabricated by repeated layering. FIG. 4(B) is a photograph of the three-dimensional shaped article fabricated in example 6.

As shown in FIG. 4(A), when a box-like three-dimensional shaped article was produced using the filament of example 2, a three-dimensional shaped article with high precision and no warping or the like was fabricated. Also, as shown in FIG. 4(B), when a box-like three-dimensional shaped article was produced using the filament of example 3, an expected three-dimensional shaped article was fabricated with some lack of smoothness due to contraction of the layered surface.

### Example 7

Other than changing the shape of the three-dimensional shaped article to be fabricated, a three-dimensional shaped article was produced using the same procedure as example 5. FIGS. 5(A) and 5(B) are photographs of the three-dimensional shaped article fabricated in example 7. FIG. 5(A) is a cup-shaped three-dimensional shaped article, and the layered surface was smooth with high precision in which unevenness could not be visually confirmed. Also, FIG. 5(B) is a honeycomb-shaped three-dimensional shaped article, and the very small portions of the honeycomb had high precision with dimensional stability in which warping and unevenness could not be visually confirmed.

### Example 8

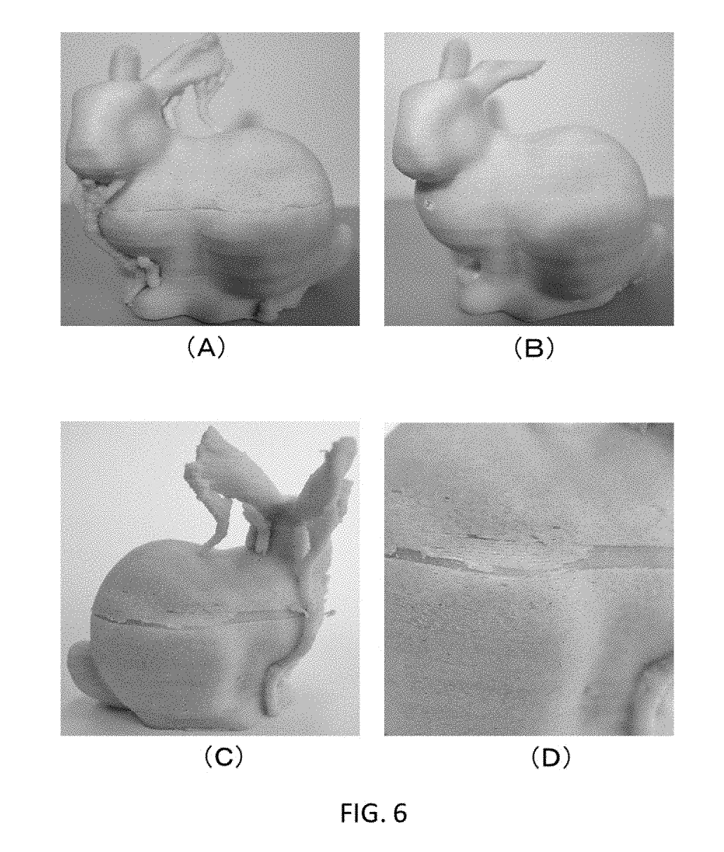

Other than using the filament fabricated in example 1 and changing the shape of the three-dimensional shaped article to be fabricated, a three-dimensional shaped article was produced using the same procedure as example 5. FIG. 6(A) is a photograph of the three-dimensional shaped article fabricated in example 8.

### Example 9

Other than using the filament fabricated in example 2, a three-dimensional shaped article was produced using the same procedure as example 8. FIG. 6(B) is a photograph of the three-dimensional shaped article fabricated in example 9.

### Example 10

Other than using the filament fabricated in example 4, a three-dimensional shaped article was produced using the same procedure as example 8. FIG. 6(C) is a photograph of the three-dimensional shaped article fabricated in example 10, and FIG. 6(D) is an enlarged photograph of the FIG. 6(C).

As shown in FIG. 6(A), when a three-dimensional shaped article is produced using the filament of example 1 containing 40 wt % of glass wool, there were locations in which dripping occurred on the surface of the three-dimensional shaped article due to the difference in fluidity of the thermoplastic resin and glass wool, but a three-dimensional shaped article was produced without a problem. Also, as shown in FIGS. 6(C) and 6(D), when a three-dimensional shaped article was produced using the filament of example 4 containing 5 wt % of glass wool, there were locations in which distortion occurred during layered due to the percentage of heat contraction, but a three-dimensional shaped article was produced without a problem. On the other hand, as shown in FIG. 6(B), when a three-dimensional shaped article was produced using the filament of example 2 containing 20 wt % of glass wool, a high-precision three-dimensional shaped article without heat contraction and dripping was produced. In view of the above-noted results, a three-dimensional shaped article could not be produced using a PP filament to which glass wool had not been added (comparative example 2). However, three-dimensional shaped articles of various shapes could be produced (examples 5 to 10) using a thermoplastic resin containing glass wool. Also, as shown in examples 5 to 10, a three-dimensional shaped article could be produced in each case the glass wool content was 5 to 40 wt %. However, the precision of the three-dimensional shaped article varied due to the glass wool content, and it was apparent that a three-dimensional shaped article could be obtained with high precision at around 20 wt %.

### Example 11

Other than using polyacetal (POM, Duracon (registered trademark) POM TF-30 manufactured by Polyplastics Co., Ltd.) as the thermoplastic resin and setting the glass wool content in the filament to 25 wt %, a filament was fabricated using the same procedure as in example 1. Next, other than setting the nozzle temperature to 220° C. to 240° C., a three-dimensional shaped article was fabricated using the same procedure as comparative example 2.

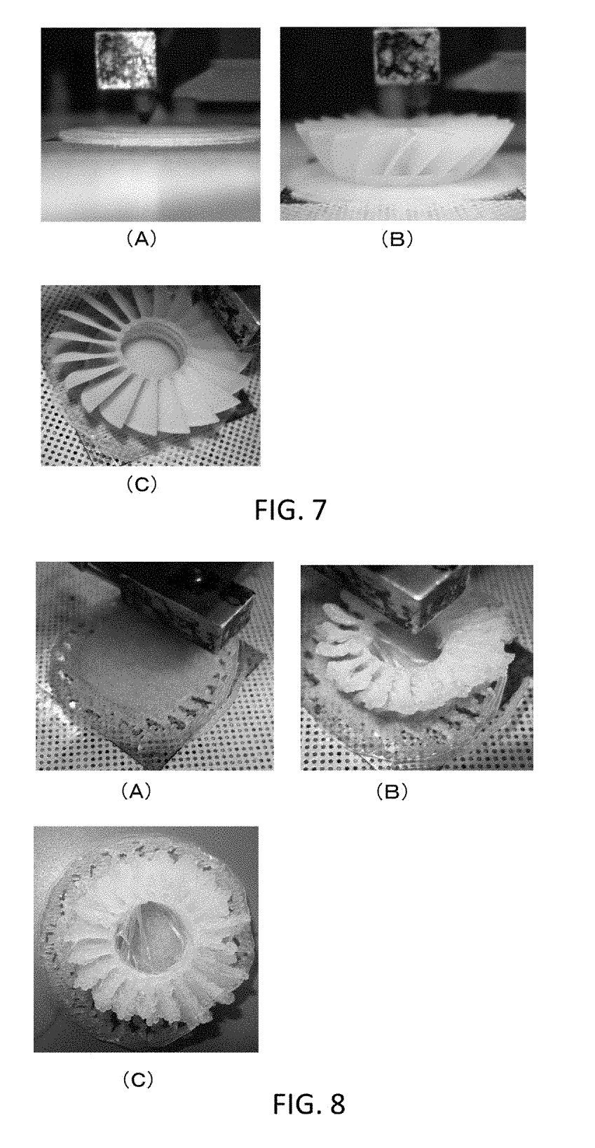

FIG. 7(A) is a photograph of ongoing fabrication of a raft for placement of a three-dimensional shaped article with thermoplastic resin being further layered on the thermoplastic resin which was made to anchor to the holes of the shaping table;

FIG. 7(B) is a photograph in which the thermoplastic resin has been layered on the raft; and

FIG. 7(C) is a photograph of the three-dimensional shaped article fabricated in example 11.

As shown in FIG. 7(A), the raft adhered closely to the shaping table in a uniform manner without the occurrence of heat contraction, and as shown in FIGS. 7(B) and 7(C), a three-dimensional shaped article (fan) was manufactured in accordance with the data.

### Comparative Example 3

Other than omitting glass wool, a filament was fabricated using the same procedure as in example 11 and three-dimensional shaping was carried out.

FIG. 8(A) is a photograph of ongoing fabrication of a raft for placement of a three-dimensional shaped article with thermoplastic resin being further layered on the thermoplastic resin which was made to anchor to the holes of the shaping table;

FIG. 8(B) is a photograph in which the thermoplastic resin has been layered on the raft; and

FIG. 8(C) is a photograph of the three-dimensional shaped article fabricated in comparative example 3.

As shown in FIG. 8(A), when polyacetal containing no glass wool was used, a portion of the raft peeled away from the shaping table due to heat contraction during raft fabrication. The layering adhesion is dramatically reduced due to heat contraction, as shown in FIG. 8(B), and an expected three-dimensional shaped article (fan) could not be fabricated, as shown in FIG. 8(C).

In view of the foregoing results, it is apparent that adding glass wool to a thermoplastic resin makes it possible of produce a three-dimensional shaped article using a FDM 3D printer regardless of general-purpose plastics and engineering plastics.

### INDUSTRIAL APPLICABILITY

The filament of the present disclosure makes it possible to produce a three-dimensional shaped article with a FDM 3D printer using a general-purpose thermoplastic resin as a base material, and is therefore useful in further dissemination of 3D printers.

1. A method for producing a three-dimensional shaped article by fused deposition modeling, the method comprising:
a melting step for melting a glass-wool-containing thermoplastic resin containing glass wool; and
a layering step for layering the melted glass-wool-containing thermoplastic resin.

2. The method for producing a three-dimensional shaped article of claim 1, wherein the amount of glass wool contained in the glass-wool-containing thermoplastic resin is 5 to 40 wt %.

3. The method for producing a three-dimensional shaped article of claim 2, wherein the amount of glass wool contained in the glass-wool-containing thermoplastic resin is 15 to 25 wt %.

4. The method for producing a three-dimensional shaped article of claim 1 wherein the thermoplastic resin is polypropylene or polyacetal.

5. The method for producing a three-dimensional shaped article of claim 2, wherein the thermoplastic resin is polypropylene or polyacetal.

6. The method for producing a three-dimensional shaped article of claim 3, wherein the thermoplastic resin is polypropylene or polyacetal.

7. A filament for producing a three-dimensional shaped article by fused deposition modeling, wherein
the filament is a glass-wool-containing thermoplastic resin containing glass wool.

8. The filament for producing a three-dimensional shaped article of claim 7, wherein the amount of glass wool contained in the glass-wool-containing thermoplastic resin is 5 to 40 wt %.

9. The filament for producing a three-dimensional shaped article of claim 8, wherein the amount of glass wool contained in the glass-wool-containing thermoplastic resin is 15 to 25 wt %.

10. The filament for producing a three-dimensional shaped article of claim 7, wherein the thermoplastic resin is polypropylene or polyacetal.

11. The filament for producing a three-dimensional shaped article of claim 8, wherein the thermoplastic resin is polypropylene or polyacetal.

12. The filament for producing a three-dimensional shaped article of claim 9, wherein the thermoplastic resin is polypropylene or polyacetal.

13. The filament for producing a three-dimensional shaped article of claim 7, wherein the filament has a diameter of 1.75 mm to 2.85 mm and a length of at least 50 cm or more.

14. The filament for producing a three-dimensional shaped article of claim 8, wherein the filament has a diameter of 1.75 mm to 2.85 mm and a length of at least 50 cm or more.

15. The filament for producing a three-dimensional shaped article of claim 9, wherein the filament has a diameter of 1.75 mm to 2.85 mm and a length of at least 50 cm or more.

16. The filament for producing a three-dimensional shaped article of claim 10, wherein the filament has a diameter of 1.75 mm to 2.85 mm and a length of at least 50 cm or more.

17. The filament for producing a three-dimensional shaped article of claim 11, wherein the filament has a diameter of 1.75 mm to 2.85 mm and a length of at least 50 cm or more.

18. The filament for producing a three-dimensional shaped article of claim 12, wherein the filament has a diameter of 1.75 mm to 2.85 mm and a length of at least 50 cm or more.
